(19) United States
(12) Patent Application Publication
(10) Pub. No.: US 2016/0314903 A1
(43) Pub. Date: Oct. 27, 2016

(54) Capacitor

(71) Applicant: Siemens Aktiengesellschaft, München (DE)

(72) Inventors: Vladimir DANOV, Erlangen (DE); Andreas KOCH, Neunkirchen am Brand (DE); Richard MATZ, Bruckmuehl (DE)

(73) Assignee: SIEMENS AKTIENGESELLSCHAFT, Muenchen (DE)

(21) Appl. No.: 15/104,619

(22) PCT Filed: Dec. 9, 2014
(86) PCT No.: PCT/EP2014/077051

§ 371 Date: Jun. 15, 2016

(30) Foreign Application Priority Data
Jan. 10, 2014 (DE) 10 2014 200 347.4

(51) Int. Cl. H01G 4/38; H01G 4/258; H01G 4/005; H01G 4/12; H01G 4/28

(52) U.S. Cl. CPC H01G 4/38; H01G 4/12; H01G 4/28; H01G 4/005; H01G 4/258

(57) ABSTRACT

A capacitor assembly structure may include multiple capacitors, and may be used for an electric cable, a coaxial cable, and/or a resonant heat output, for example. Accordingly, a capacitor device formed by a single cylinder may be replaced by a number of cylindrical capacitors that are electrically connected in parallel and have a smaller diameter, with or without connecting a centrally arranged, large tube which optionally is also in the form of a cylindrical capacitor. Every single cylinder may have the same structure. Further, the single cylinder may be electrically contacted via both end surfaces thereof, and therefore suitable for being integrated in series into a current-carrying electrical conductor, e.g., a cable and/or a conductive tube.

### CROSS-REFERENCE TO RELATED APPLICATIONS

This application is a U.S. National Stage Application of International Application No. PCT/EP2014/077051 filed Dec. 9, 2014, which designates the United States of America, and claims priority to DE Application No. 10 2014 200 347.4 filed Jan. 10, 2014, the contents of which are hereby incorporated by reference in their entirety.

### TECHNICAL FIELD

The invention relates to a capacitor, in particular to a structure comprising a plurality of capacitors for an electric cable, a coaxial cable and/or a resonant heat output.

### BACKGROUND

Passive components that can be operated at high voltages, currents, and temperatures, for example at 10 kV, 300 A, and 500° C., are increasingly required for power-electronic applications. There is in particular a need for capacitive components that exhibit a charge capacity up into the pF range and which can be used under extreme operating conditions of this sort.

The application fields of power electronics are found, for example, in heavy machines, in oil extraction and/or the coal and steel industry.

### SUMMARY

One embodiment provides a capacitor arrangement comprising a plurality of capacitors in cylindrical form, wherein a large number of cylindrical capacitors of smaller diameter are arranged around a cylindrical carrier.

In a further embodiment, the large number of cylindrical capacitors of smaller diameter are connected electrically in parallel.

In a further embodiment, the large number of cylindrical capacitors of smaller diameter have the same structure.

In a further embodiment, at least one cylindrical capacitor of smaller diameter has such a structure that the capacitor electrodes are located between dielectric ceramic layers, and/or are each arranged staggered with axial alternation and/or the capacitor electrodes can be contacted from the outside at the respective cylinder end.

In a further embodiment, the cylindrical carrier is also a cylindrical capacitor.

In a further embodiment, the centrally arranged cylindrical capacitor of larger diameter is also connected electrically in parallel with the cylindrical capacitors of smaller diameter.

In a further embodiment, the cylindrical carrier is a tube through which coolant flows.

### BRIEF DESCRIPTION OF THE DRAWINGS

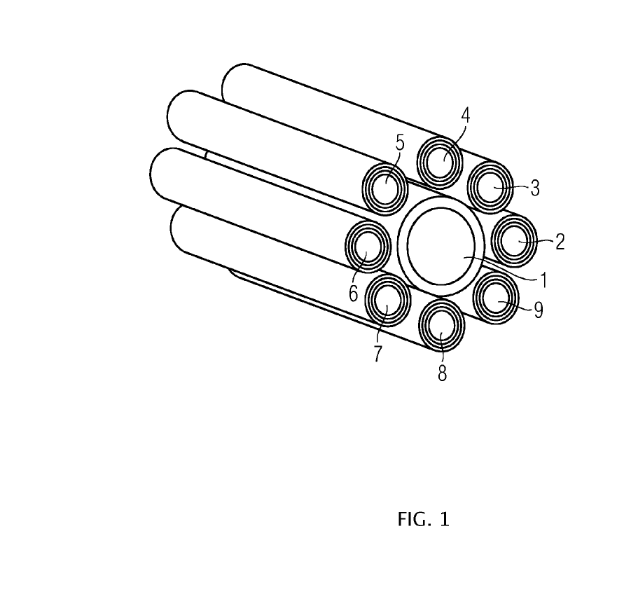

Example aspects of the invention are explained in more detail below with reference to the sole FIG. 1, which illustrates a perspective view of a cylindrical capacitor arrangement around a large tube, according to an example embodiment of the invention.

### DETAILED DESCRIPTION

Embodiments of the present invention provide a capacitor that can be adapted as easily as possible to operation at high voltages, currents and temperatures, and which has an easily adjustable charge capacity.

A first aspect of the invention relates to the bundling of cylindrical capacitors, e.g., the bundling of cylindrical capacitors that comprise at least two electrically conductive layers that are separated from one another galvanically by a ceramic dielectric layer, e.g., capable of being manufactured by winding with a green tape and/or by a thermal spray process. Cylindrical capacitors of this sort are known from DE 10 2012 217 168.1, and from 2014E00471DE (both unpublished).

Embodiments of the invention may provide a compact method of construction that also ensures a dissipation of the waste heat of the capacitors.

It has been found that bundling small cylindrical capacitors around a larger tube is advantageous. A trade-off takes place here between arrangements in which the heat is easily dissipated and the compactness of the device, i.e., the space utilization.

In one embodiment that cylindrical capacitors are arranged on the outer wall at least in partial regions of a tube through which coolant flows.

In one embodiment, further, a tube, for example a cooling tube or a larger cylindrical capacitor, is surrounded at least in part by cylindrical capacitors of smaller diameter.

In one embodiment, the cylindrical capacitors with smaller diameters are connected electrically in parallel.

The internal diameter of the small cylindrical capacitors lies in the range from 5 mm to 70 mm, preferably from 10 mm to 30 mm, in particular from 15 mm to 25 mm, i.e. for example 20 mm.

The wall thickness of the small and large capacitors lies in the range between 1 mm and 10 mm, depending on the number of layers which—again preferred—are arranged according to the structure of a cylindrical capacitor disclosed in DE 10 2012 217 168.1 and in 2014E00471DE. The capacitor electrodes here are located between the dielectric ceramic layers, the capacitor electrodes are arranged staggered with axial alternation, and are brought out and contacted at the respective cylinder end.

Depending on the number of layers, this means that a wall thickness of between 1 and 10 mm results, which is added to the internal diameter for calculation of the external diameter.

Cylindrical capacitors with a different structure can, of course, also be used.

The length of the cylindrical capacitors lies in the range between 10 mm and 300 mm, for example between 30 and 300 mm, in particular between 50 and 200 mm, i.e. for example at between 100 and 120 mm.

The dimensions stated here are given by way of example; the principle of the invention disclosed here can, of course, also be employed for significantly larger and significantly smaller components.

FIG. 1 shows the main tube 1, which may be either a cylindrical capacitor, an electrically passive tube, or other open or closed cylinder, according to one embodiment. The cylindrical capacitors 2, 3, 4, 5, 6, 7, 8 and 9 are arranged around the main tube 1. These cylindrical capacitors can be the same or different in their structure and in their interconnection.

The cylindrical capacitors (2, 3, 4, 5, 6, 7, 8 and 9) may be all the same, and constructed according to principles disclosed in the above-mentioned applications, and may be all connected electrically in parallel. In other embodiments, only parts of the surrounding cylindrical capacitors are connected in parallel, depending on the relevant requirements.

In order to dissipate waste heat from the peripheral capacitors (2, 3, 4, 5, 6, 7, 8 and 9) into the coolant, they may be surrounded by a thermally conductive casting mass.

The disclosed design permits a highly variable design in terms of the capacitance and breakdown voltage, a hollow cylindrical form that may be advantageous for the flow of coolant, high temperature resistance and voltage resistance, optimized utilization of the space, as the bundling of smaller cylinders allows a greater capacitor area (capacitance) to be housed per unit volume, and better cooling capability through assembly of the cylindrical capacitors on the outer surface of, for example, a coolant tube.

Some embodiments provide a capacitor, e.g., a structure comprising a plurality of capacitors for an electric cable, a coaxial cable and/or a resonant heat output. Thus, a conventional capacitor device consisting of a single cylinder may be replaced by capacitor including a plurality of cylindrical capacitors connected electrically in parallel and having a smaller diameter, with or without the additional connection of a centrally arranged, large tube which may also form a cylindrical capacitor. In some embodiments, each single cylinder may have the same structure. It is, for example, electrically contacted through its two end surfaces, and is thus suitable for being installed in series into a current-carrying electrical conductor such as a cable and/or a conductive tube.

What is claimed is:

1. A capacitor arrangement comprising:
a cylindrical carrier having a cylindrical carrier diameter; and
a plurality of cylindrical capacitors arranged around a circumference of the cylindrical carrier, each cylindrical capacitor having a diameter smaller than the cylindrical carrier diameter.

2. The capacitor arrangement of claim 1, wherein the plurality cylindrical capacitors are electrically connected to each other in parallel.

3. The capacitor arrangement of claim 1, wherein the plurality of cylindrical capacitors have the same structure as each other.

4. The capacitor arrangement of claim 1, wherein at least one of the plurality of cylindrical capacitors includes capacitor electrodes located between dielectric ceramic layers.

5. The capacitor arrangement of claim 1, wherein the cylindrical carrier is a further cylindrical capacitor in addition to the plurality of cylindrical capacitors arranged around the cylindrical carrier.

6. The capacitor arrangement of 5, wherein the cylindrical carrier is electrically connected in parallel with the plurality of cylindrical capacitors arranged around the cylindrical carrier.

7. The capacitor arrangement of claim 1, wherein the cylindrical carrier is a tube configured to carry a flow of coolant.

8. The capacitor arrangement of claim 1, wherein at least one of the plurality of cylindrical capacitors includes capacitor electrodes arranged in a staggered manner along an axial direction.

9. The capacitor arrangement of claim 1, wherein at least one of the plurality of cylindrical capacitors includes capacitor electrodes that provide a contact point at one or both axial ends of the cylindrical capacitor.
